(19) United States
(12) Patent Application Publication
(10) Pub. No.: US 2019/0309846 A1
(43) Pub. Date: Oct. 10, 2019

(54) SEQUENTIAL GEARBOX

(71) Applicant: Maria Gabriella BIAGI, Massa Lombarda (Ravenna) (IT)

(72) Inventor: Maria Gabriella BIAGI, Massa Lombarda (Ravenna) (IT)

(21) Appl. No.: 15/969,507

(22) Filed: May 2, 2018

(30) Foreign Application Priority Data
Apr. 9, 2018 (IT) 102018000004326

(51) Int. Cl. F16H 63/18

(52) U.S. Cl. CPC F16H 63/18

(57) ABSTRACT

A sequential gearbox including a selecting system which allows the obtainment of a gearbox which is more compact and faster than prior art gearboxes.

This application claims priority to Italian Patent Application 102018000004326 filed Apr. 9, 2018, the entirety of which is incorporated by reference herein.

### DESCRIPTION

This invention relates to a selecting system for sequential gearboxes, which allows the obtainment of a gearbox that is more compact and faster than prior art gearboxes.

In gearboxes, mechanical selecting systems are used which allow selection of the gear pair which transmits the torque, and therefore the actual gearbox gear ratio.

Some prior art selecting systems are described in patent documents E P2143978, J PH0419462, E P1072823, E P2273160.

However, the prior art selecting systems have disadvantages such as having complex mechanical setups and large dimensions. Due to the complex mechanical setup, such selecting systems increase the risk that such a gearbox will suffer from malfunctions. That complex mechanical setup also increases the time needed for selecting gears.

This description relates to a sequential gearbox.

The aim of this description is to make available a sequential gearbox which overcomes the above-mentioned disadvantages of prior art sequential gearboxes.

That aim is achieved by means of a sequential gearbox in accordance with this description. That aim is also achieved by means of a sequential gearbox having the features set out in any one of, or in any combination of one or more of the appended claims.

The features of a sequential gearbox according to this description will become clearer from the following detailed description of an example embodiment of a sequential gearbox according to this description, provided by way of example only and without limiting the concepts claimed.

The following detailed description refers to the accompanying drawings, in which:

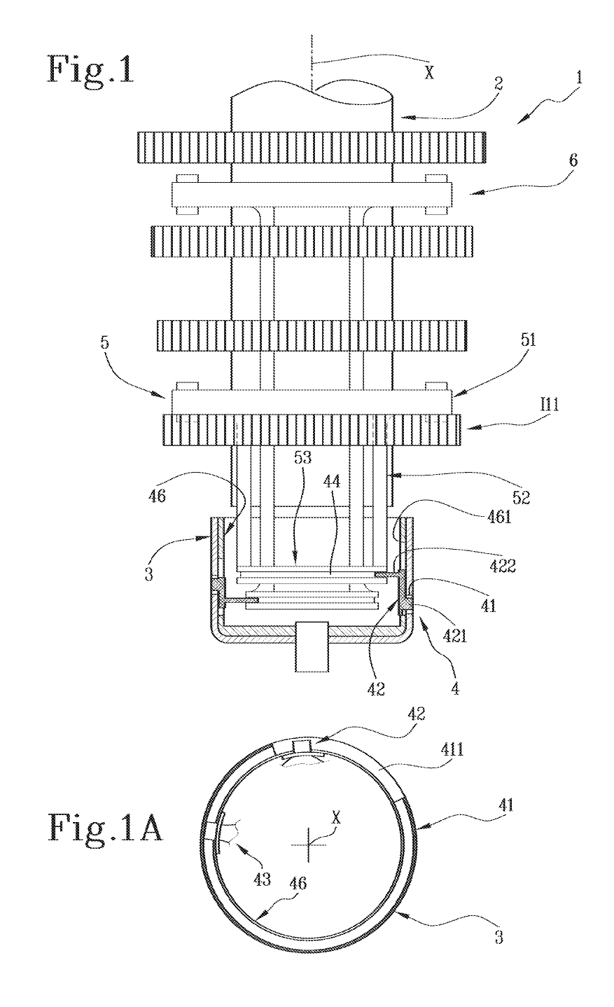

FIG. 1 is a schematic top view of one possible embodiment of a part of a gearbox in accordance with this description, whilst that gearbox adopts a first operating condition corresponding to selection of a first gear;

FIG. 1A is a partial rear view of two coupling elements and of a selecting body which belong to the gearbox, whilst those coupling elements and selecting body adopt a first positioning relative to one another, which corresponds to and/or causes that first operating condition of the gearbox;

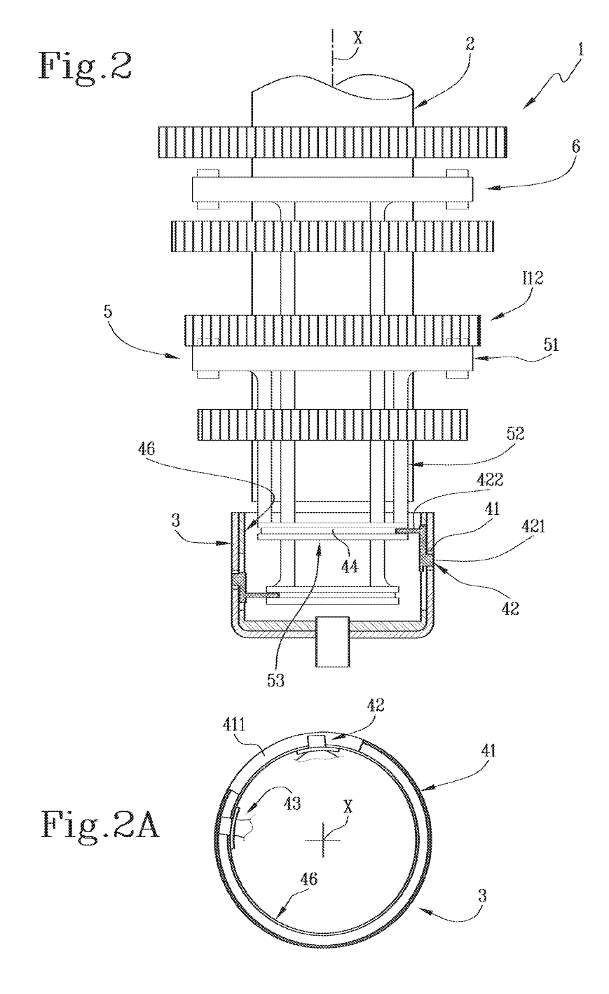

FIG. 2 is a schematic top view of the part shown in FIG. 1, whilst that gearbox adopts a second operating condition corresponding to selection of a second gear;

FIG. 2A is a partial rear view of the components shown in FIG. 1A, whilst those components adopt a second positioning relative to one another, which corresponds to and/or causes that second operating condition of the gearbox;

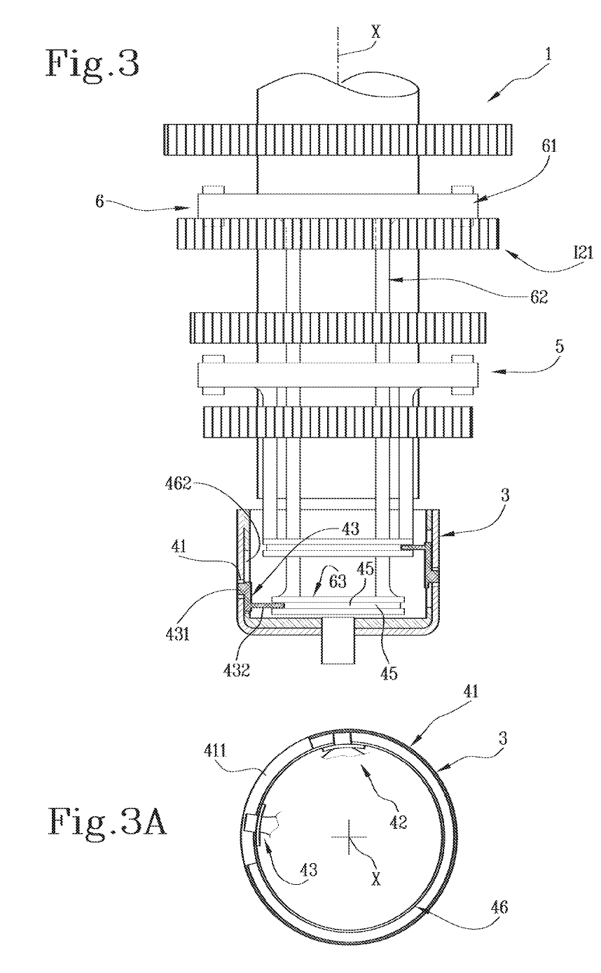

FIG. 3 is a schematic top view of the part shown in FIG. 1, whilst that gearbox adopts a third operating condition corresponding to selection of a third gear;

FIG. 3A is a partial rear view of the components shown in FIG. 1A, whilst those components adopt a third positioning relative to one another, which corresponds to and/or causes that third operating condition of the gearbox;

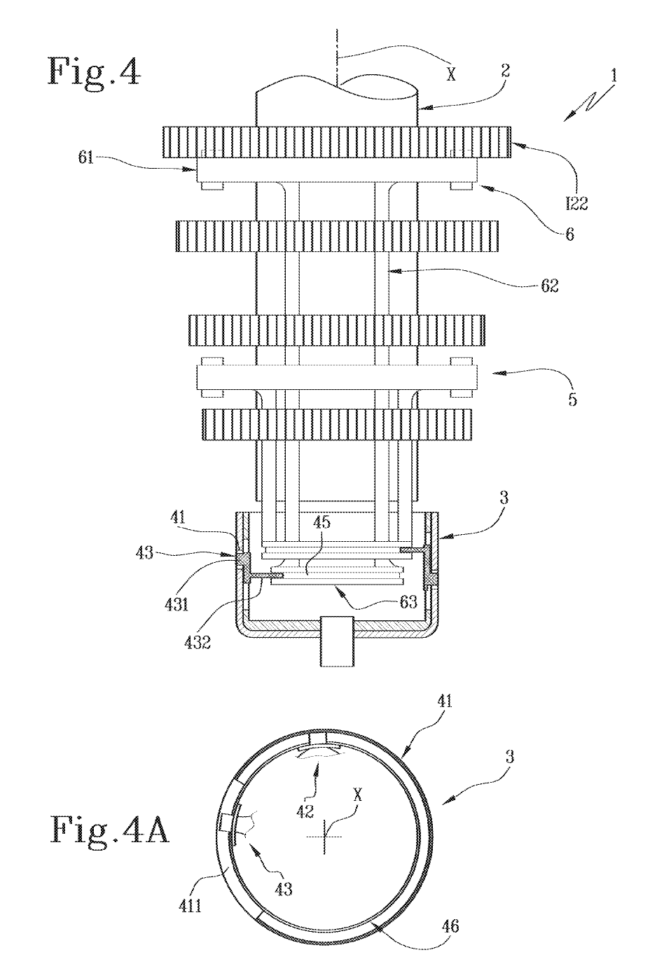

FIG. 4 is a schematic top view of the part shown in FIG. 1, whilst that gearbox adopts a fourth operating condition corresponding to selection of a fourth gear;

FIG. 4A is a partial rear view of the components of FIG. 1A, whilst those components adopt a fourth positioning relative to one another, which corresponds to and/or causes that fourth operating condition of the gearbox;

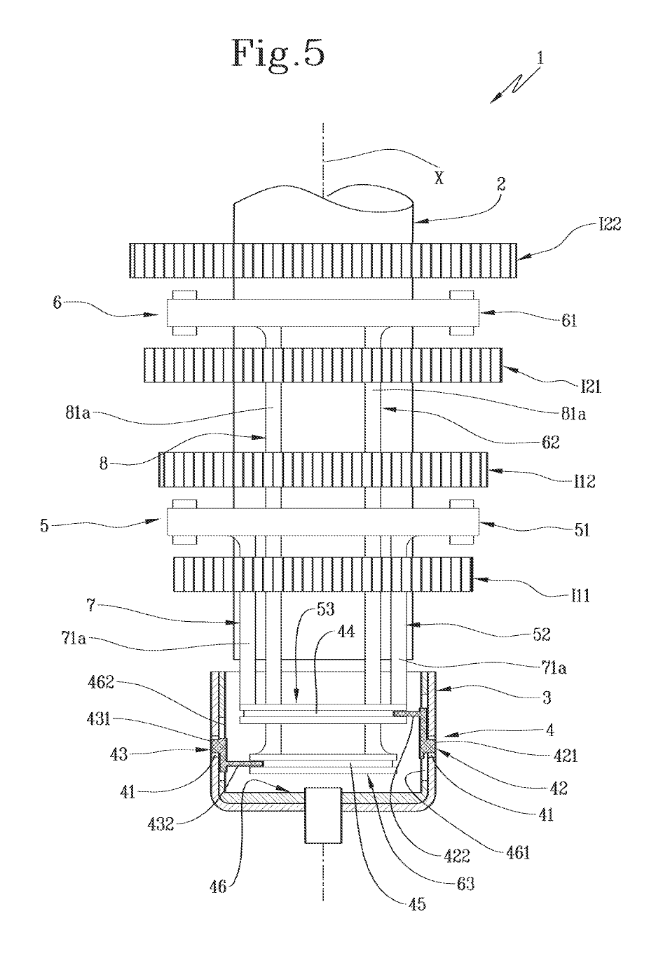

FIG. 5 is a schematic top view of the part of FIG. 1, whilst that gearbox adopts a non-operating condition corresponding to a gearbox neutral condition;

FIG. 5A is a rear view of the components of FIG. 1A, whilst those components adopt a starting positioning relative to one another which corresponds to and/or causes that neutral condition of the gearbox;

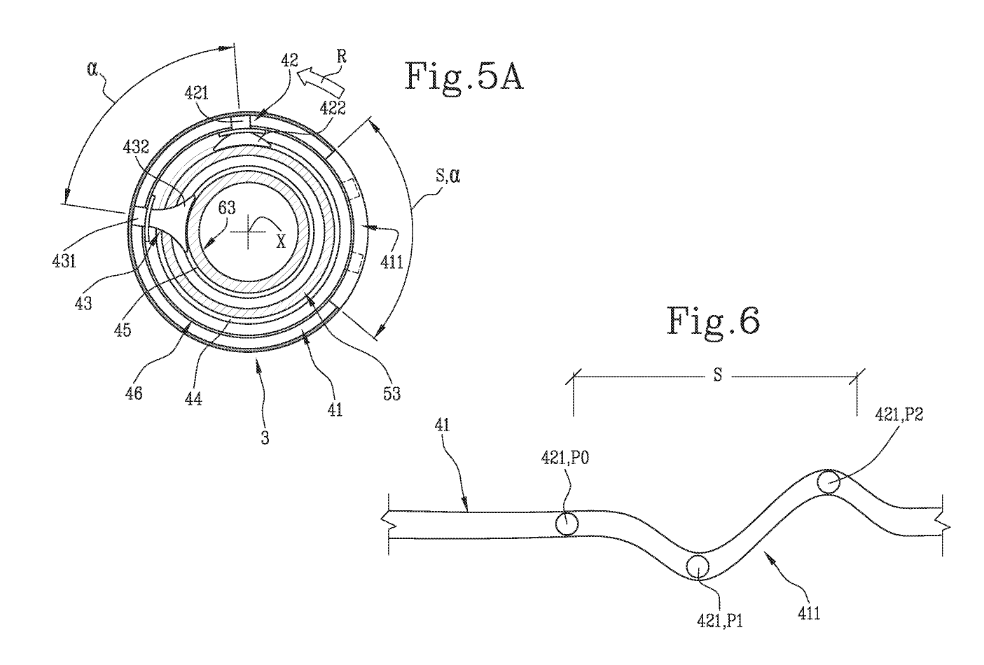

FIG. 6 is a schematization of a sliding of any of the coupling elements relative to the above-mentioned selecting body, by means of that sliding it being possible to make the gearbox pass from the neutral condition to the first operating condition and subsequently to the second operating condition, or to make the gearbox pass from the second operating condition to the third operating condition and subsequently to the fourth operating condition;

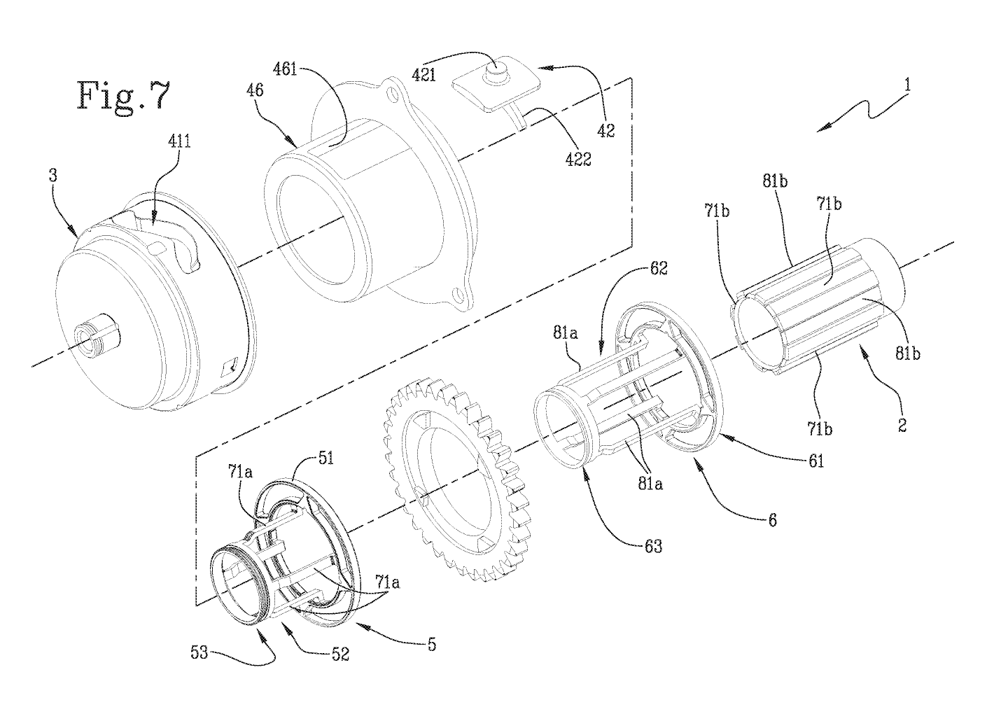

FIG. 7 is an exploded diagram of several parts of a specific preferred embodiment of a gearbox according to this description;

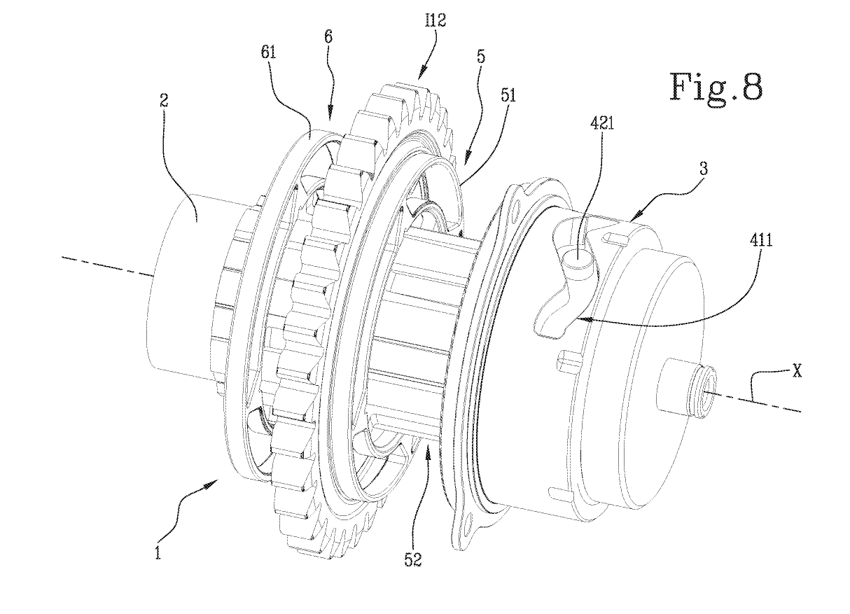

FIG. 8 shows the parts of FIG. 7 in an assembled condition.

A sequential gearbox in accordance with this description comprises a shaft 2. That shaft 2 may be subject to a rotary motion around a longitudinal axis X of the shaft 2. That axis X is indicated in FIGS. 1 to 5A and 8.

The gearbox comprises a plurality of gears I11, I12, I21, and I22. Those gears I11 to I22 are idly mounted on the shaft. The gears I11-I22 are associated with another plurality of respective gears mounted on another shaft of the gearbox. Those other gears and the other shaft are not shown.

The shaft 2 may, for example, be a primary shaft or a secondary shaft of the gearbox.

Each of the gears I11 to I22 may adopt a respective condition of coupling with said rotary motion of the shaft 2. That respective coupling condition, even by means of the above-mentioned other gears mounted on the other shaft, corresponds to the selection of a respective gear of the gearbox.

The gearbox comprises a selecting system. The selecting system is configured for selecting one of the gears I11-I22, so that a respective gear of the gearbox is selected. Therefore, the selecting system is connected to a control system which allows a user to act on the selecting system in such a way as to set the gearbox gear.

The selecting system comprises a selecting body 3. The selecting body defines an axis of the selecting body 3. The selecting body 3 has a respective axial development or extent along its axis and a respective angular development or extent around its axis. The selecting body 3 is positioned and/or mounted so that the respective axis coincides with the longitudinal axis X.

Since the selecting body 3 has an angular development or extent around its axis and since its axis coincides with the longitudinal axis X, the selecting body 3 is positioned around the longitudinal axis X.

Since the selecting body 3 has an axial development or extent along its axis and since its axis coincides with the longitudinal axis X, the selecting body 3 is positioned along the longitudinal axis X.

The selecting body 3 is positioned along and around that longitudinal axis X.

The selecting body 3 is positioned coaxially relative to that longitudinal axis X and/or on the longitudinal axis X.

The selecting body 3 is mounted so that it can be subject to a rotary movement around said axis of the selecting body 3, and therefore around the longitudinal axis X. That rotary movement may occur in the direction of the arrow R of FIG. 5A. That rotary movement is a rotary movement of the selecting body 3 on itself.

Therefore, the selecting body 3 could be constrained to a fixed frame, not shown, in such a way as to be able to be subject to that rotary movement.

In FIGS. 1, 2, 3, 4 and 5, the selecting body 3 is shown in cross-section according to a first sectioning surface. That first sectioning surface is parallel to the longitudinal axis X and is positioned along a cross-section line passing through the longitudinal axis X. That cross-section line comprises a first stretch and a second stretch. Those first and second stretches are straight lines and pass through the longitudinal axis X. As regards the possible embodiment in FIGS. 1 to 5A, those first and second stretches shall be considered inclined at an angle to each other, as described in more detail below. Therefore, as regards the embodiment of FIGS. 1 to 5A, that first cross-section surface has a split profile, defined by that cross-section line.

In FIGS. 1A, 2A, 3A, 4A and 5A, the selecting body 3 is shown in cross-section according to a second sectioning surface, which is orthogonal to the longitudinal axis X. Therefore, in FIGS. 1A, 2A, 3A, 4A and 5A, the angular development of the selecting body 3 is visible.

The angular development of the selecting body 3 is a substantially circular development around its axis. Therefore, the selecting body 3 could be considered a bell-housing or selecting unit located around and coaxially relative to the longitudinal axis X of the shaft 2.

The selecting system comprises a cam coupling 4. The cam coupling 4 is configured for making the above-mentioned rotary movement of the selecting body 3 sequentially cause the respective coupling conditions of the gears I11 to I22. Therefore, the selecting system is configured so that the rotary movement of the selecting body 3 makes those coupling conditions occur one after another.

That cam coupling 4 is positioned around the longitudinal axis X. That cam coupling 4 is positioned along the angular development of the selecting body 3. That cam coupling 4 is also positioned coaxially relative to the longitudinal axis X.

Considering that the selecting body 3 is positioned around the longitudinal axis X, and the cam coupling 4 makes a rotary movement of the selecting body 3 around that longitudinal axis X cause the sequential selection of the gears, the selecting system defines, for selection of the gears, a single “selecting line” coinciding with the longitudinal axis X of the shaft 2. In that way, the gearbox is very compact.

The selecting system comprises at least one first engaging body 5. The selecting system comprises a second engaging body 6.

The first engaging body 5 is associated with a respective first gear I11 and with a respective second gear I12.

The condition which sees coupling between the rotary motion of the shaft 2 and the first gear I11 associated with the first engaging body 5, corresponds to selection of a first gear of the gearbox. The condition which sees coupling between the rotary motion of the shaft 2 and the second gear I12 associated with the first engaging body 5, corresponds to selection of a second gear of the gearbox.

The first engaging body 5 can adopt a respective non-operating condition, in which it does not cause the coupling condition of any gear. In FIGS. 5, 3 and 4, the first engaging body 5 adopts the respective non-operating condition. The first engaging body 5 can adopt a respective first engaged condition, in which it causes the coupling condition of the respective first gear I11. In FIG. 1 the first engaging body 5 adopts the respective first engaged condition.

The first engaging body 5 can adopt a respective second engaged condition, in which it causes the coupling condition of the respective second gear I12. In FIG. 2 the first engaging body 5 adopts the respective second engaged condition.

The first engaging body 5 comprises a respective engaging portion 51. That respective engaging portion 51 of the first engaging body 5, in the respective first engaged condition, causes the coupling condition of the respective first gear I11 with the rotary motion of the shaft 2.

That respective engaging portion 51 of the first engaging body 5, in the respective second engaged condition, causes the coupling condition of the respective second gear I12 with the rotary motion of the shaft 2.

The engaging portion 51 of the first engaging body 5 may be considered an engaging ring belonging to the first engaging body 5.

The second engaging body 6 is associated with a respective first gear I21 and with a respective second gear I22.

The condition which sees coupling between the rotary motion of the shaft 2 and the first gear I21 associated with the second engaging body 6, corresponds to selection of a third gear of the gearbox. The condition which sees coupling between the rotary motion of the shaft 2 and the second gear I22 associated with the second engaging body 6, corresponds to selection of a fourth gear of the gearbox.

The second engaging body 6 can adopt a respective non-operating condition, in which it does not cause the coupling condition of any gear. In FIGS. 5, 1 and 2, the second engaging body 6 adopts the respective non-operating condition. Therefore, in FIG. 5 the gearbox is in neutral.

The second engaging body 6 can adopt a respective first engaged condition, in which it causes the coupling condition of the respective first gear I21. In FIG. 3 the second engaging body 6 adopts the respective first engaged condition.

The second engaging body 6 can adopt a respective second engaged condition, in which it causes the coupling condition of the respective second gear I22. In FIG. 4 the second engaging body 6 adopts the respective second engaged condition.

The second engaging body 6 comprises a respective engaging portion 61.

That respective engaging portion 61 of the second engaging body 6, in the respective first engaged condition, causes the coupling condition of the respective first gear I21 with the rotary motion of the shaft 2.

That respective engaging portion 61 of the second engaging body 6, in the respective second engaged condition, causes the coupling condition of the respective second gear I22 with the rotary motion of the shaft 2.

The engaging portion 61 of the second engaging body 6 may be considered an engaging ring belonging to the second engaging body 6.

The first engaging body 5 is mounted relative to the shaft 2 so that it can be subject to a sleeve-like operating movement of the first engaging body 5 relative to the shaft 2. That operating movement of the first engaging body 5 comprises, one after another, at least one shift from the respective non-operating condition to the respective first engaged condition, at least one shift from the respective first engaged condition to the respective second engaged condition, and at least one shift from the respective second engaged condition to the respective non-operating condition.

The second engaging body 6 is mounted relative to the shaft 2 so that it can be subject to an operating movement of the second engaging body 6 relative to the shaft 2. That operating movement of the second engaging body 6 comprises, one after another, at least one shift from the respective non-operating condition to the respective first engaged condition, and one shift from the respective first engaged condition to the respective second engaged condition. That operating movement of the second engaging body 6 could also comprise, subsequently, a shift from the respective second engaged position to the respective non-operating condition.

The first engaging body 5 is mounted and/or constrained in a sleeve-like way on the shaft 2, so that the operating movement of the first engaging body 5 is a sleeve-like movement relative to said shaft 2.

Therefore, that operating movement of the first engaging body 5 comprises at least one translatory component parallel to the longitudinal axis X of the shaft 2.

The second engaging body 6 is mounted and/or constrained in a sleeve-like way on the shaft 2, so that the operating movement of the second engaging body 6 is a sleeve-like movement relative to said shaft 2.

Therefore, that operating movement of the second engaging body 6 comprises at least one translatory component parallel to the longitudinal axis X of the shaft 2.

The cam coupling 4 couples the rotary movement of the selecting body 3 to the operating movement of the first engaging body 5 and to the operating movement of the second engaging body 6, so that said rotary movement sequentially causes the operating movement of the first engaging body 5 and the operating movement of the second engaging body 6.

Therefore, the cam coupling 4 is positioned around the longitudinal axis X of the shaft 2 and mechanically constrains the selecting body 3 to the first engaging body 5 and to the second engaging body 6, so that said rotary movement sequentially causes the operating movement of the first engaging body 5 and the operating movement of the second engaging body 6.

The first engaging body 5 defines an axis of the first engaging body 5. The first engaging body 5 has a respective axial development or extent along its axis and a respective angular development or extent around its axis. The first engaging body 5 is mounted and/or positioned relative to the shaft 2 so that the axis of the first engaging body 5 coincides with the longitudinal axis X.

Since the first engaging body 5 has an angular development or extent around its axis and since its axis coincides with the longitudinal axis X, the first engaging body 5 is positioned around the longitudinal axis X.

Since the first engaging body 5 has an axial development or extent along its axis and since its axis coincides with the longitudinal axis X, the first engaging body 5 is positioned along the longitudinal axis X.

The first engaging body 5 is positioned and/or mounted along and around that longitudinal axis X.

The first engaging body 5 is positioned and/or mounted coaxially relative to that longitudinal axis X and/or on the longitudinal axis X. The first engaging body 5 is positioned and/or mounted along the shaft 2 and around the shaft 2. The first engaging body 5 is positioned coaxially relative to the shaft 2.

The shaft 2 is inserted through the first engaging body 5.

The first engaging body 5 is mounted and/or constrained in a sleeve-like way on the shaft 2. The operating movement of the first engaging body 5 is a sleeve-like movement relative to said shaft 2.

The first engaging body 5 is fitted in a sleeve-like way on the shaft 2.

Therefore, that operating movement of the first engaging body 5 comprises a translatory component parallel to the longitudinal axis X of the shaft 2.

Therefore, the selecting body 3 and the first engaging body 5 are positioned coaxially relative to each other.

The selecting system has a radial extent relative to the longitudinal axis X. The first engaging body 5 and the selecting body 3 are positioned one after the other along that radial extent.

The first engaging body 5 is shown from above in FIGS. 1, 2, 3, 4 and 5.

In FIGS. 1A, 2A, 3A, 4A and 5A, the first engaging body 5 is shown in cross-section according to the above-mentioned second sectioning surface, which is orthogonal to the longitudinal axis X. Therefore, in FIGS. 1A, 2A, 3A, 4A and 5A, the angular development of the first engaging body 5 is visible.

The first engaging body 5 comprises a respective casing portion 52 which receives the shaft 2, and in which the shaft 2 is inserted, so that the operating movement of the first engaging body 5 is a sleeve-like movement relative to the shaft 2.

The second engaging body 6 defines an axis of the second engaging body 6. The second engaging body 6 has a respective axial development or extent along its axis and a respective angular development or extent around its axis. The second engaging body 6 is positioned and/or mounted relative to the shaft 2 so that the axis of the second engaging body 6 coincides with the longitudinal axis X.

Since the second engaging body 6 has an angular development or extent around its axis and since its axis coincides with the longitudinal axis X, the second engaging body 6 is positioned around the longitudinal axis X.

Since the second engaging body 6 has an axial development or extent along its axis and since its axis coincides with the longitudinal axis X, the second engaging body 6 is positioned along the longitudinal axis X.

The second engaging body 6 is positioned and/or mounted along and around that longitudinal axis X.

The second engaging body 6 is positioned coaxially relative to that longitudinal axis X and/or on the longitudinal axis X.

The second engaging body 6 is positioned and/or mounted along the shaft 2 and around the shaft 2. The second engaging body 6 is positioned coaxially relative to the shaft 2.

The shaft 2 is inserted through the second engaging body 6.

The second engaging body 6 is mounted and/or constrained in a sleeve-like way on the shaft 2. The operating movement of the second engaging body 6 is a sleeve-like movement relative to said shaft 2.

The second engaging body 6 is fitted in a sleeve-like way on the shaft 2.

Therefore, that operating movement of the second engaging body 6 comprises a translatory component parallel to the longitudinal axis X of the shaft 2.

Therefore, the selecting body 3 and the second engaging body 6 are positioned coaxially relative to each other. The selecting body 3, first engaging body 5 and second engaging body 6 are therefore positioned coaxially relative to each other and coaxially relative to the shaft 2.

The second engaging body 6, the first engaging body 5, and the selecting body 3 are positioned one after the other along the above-mentioned radial extent of the selecting system.

In that way, the selecting system is very compact, since the selecting system components are positioned on and/or along the longitudinal axis X of the shaft 2 on which the gears I11 to I22 are mounted, which are to be selected by means of the selecting system. In fact, the selecting body 3, the first engaging body 5 and the second engaging body 6 are positioned along and around the longitudinal axis X of the shaft 2, therefore defining a single “selecting line”, coinciding with the longitudinal axis X, for selecting the gearbox gears.

The second engaging body 6 is shown from above in FIGS. 1, 2, 3, 4, 5.

In FIGS. 1A, 2A, 3A, 4A and 5A, the second engaging body 6 is shown in cross-section according to the above-mentioned second sectioning surface, which is orthogonal to the longitudinal axis X. Therefore, in FIGS. 1A, 2A, 3A, 4A and 5A, the angular development of the second engaging body 6 is visible.

The second engaging body 6 comprises a respective casing portion 62 which receives the shaft 2, and in which the shaft 2 is inserted, so that the operating movement of the second engaging body 6 is a sleeve-like movement relative to the shaft 2.

It is to be considered a radial direction relative to the longitudinal axis X.

The first engaging body 5 and the second engaging body 6 are positioned, relative to said radial direction, coaxially relative to each other and to the shaft 2.

The first engaging body 5 is also mounted and/or constrained in a sleeve-like way relative to the second engaging body 6.

The operating movement of the first engaging body 5 is also a sleeve-like movement relative to the second engaging body 6.

The operating movement of the second engaging body 6 is also a sleeve-like movement relative to the first engaging body 5.

The second engaging body 6 is inserted through the first engaging body 5, so that the operating movement of the first engaging body 5 is a telescopic movement relative to the second engaging body 6, and the operating movement of the second engaging body 6 is a telescopic movement relative to the first engaging body 5.

The angular development of the first engaging body 5 is a substantially circular development around its axis, so that the first engaging body 5 can be considered a first engaging cylinder.

The angular development of the second engaging body 6 is a substantially circular development around its axis, so that the second engaging body 6 can be considered a second engaging cylinder. The cam coupling 4 comprises a channel 41. The channel 41 is made and/or defined in the selecting body 3.

The cam coupling 4 comprises a first coupling element 42 and a second coupling element 43.

The first coupling element 42 comprises a respective first part 421 engaged with the channel 41. The first coupling element 42 comprises a respective second part 422 engaged with the first engaging body 5. That first part 421 of the first element 42 could be a peg engaged with the channel 41, and that second part 422 of the first element 42 could be a hook engaged with the first engaging body 5. The first coupling element 42 could be a pawl mechanically interposed between the channel 41, or the selecting body 3, and the first engaging body 5.

The second coupling element 43 comprises a respective first part 431 engaged with the channel 41. The second coupling element 43 comprises a respective second part 432 engaged with the second engaging body 6. That first part 431 of the second element 43 could be a peg engaged with the channel 41, and that second part 432 of the second element 43 could be a hook engaged with the second engaging body 6. The second coupling element 43 could be a pawl mechanically interposed between the channel 41, or the selecting body 3, and the second engaging body 6.

The cam coupling 4 is configured so that the above-mentioned rotary movement of the selecting body 3 corresponds to sliding of the respective first part 421 of the first coupling element 42 and of the respective first part 431 of the second coupling element 43 along said channel 41.

The channel 41 comprises at least one variable stretch 411.

The cam coupling 4 is configured so that the sliding of the respective first part 421 of the first coupling element 42 in the variable stretch 411 causes a longitudinal motion component of the first coupling element 42. That longitudinal motion component is to be considered along a direction parallel to said longitudinal axis X. The above-mentioned translatory component of the operating movement of the first engaging body 5 corresponds to and/or is caused by that longitudinal motion component of the first coupling element 42, by means of engagement of the second part 422 of the first element 42 with the first engaging body 5.

The cam coupling 4 is configured so that the sliding of the respective first part 431 of the second coupling element 43 in the variable stretch 411 causes a longitudinal motion component of the second coupling element 43. That longitudinal motion component of the second coupling element 43 is to be considered along a direction parallel to said longitudinal axis X. The above-mentioned translatory component of the operating movement of the second engaging body 6 corresponds to and/or is caused by that longitudinal motion component of the second coupling element 43, by means of engagement of the second part 432 of the second element 43 with the second engaging body 6.

Therefore, the cam coupling 4 is configured so that, by means of the engagement of the respective second part 422 of the first element 42 with the first engaging body 5, that longitudinal motion component of the first coupling element 42 causes the operating movement of the first engaging body 5.

Therefore, the cam coupling 4 is configured so that, by means of the engagement of the respective second part 432 of the second element 43 with the second engaging body 6, that longitudinal motion component of the second coupling element 43 causes the operating movement of the second engaging body 6.

The cam coupling 4 is configured so that sliding of the first part 431 of the second element 43 along the variable stretch 411 occurs after sliding of the first part 421 of the first element 42 along the variable stretch 411, so that the respective coupling conditions of the gears I11 to I22 occur sequentially, and therefore so that the gears are selected sequentially.

In FIG. 6 the channel 41 is shown stretched out, therefore as if the plane of FIG. 6 were the outstretched angular development of the selecting body 3.

The selecting system comprises a first drawing system 7. The first drawing system 7 is interposed between the first engaging body 5 and the shaft 2, so that corresponding to the rotary motion of the shaft 2 there is an equal rotary motion of the first engaging body 5. The first drawing system 7 comprises a plurality of arms which belong to the casing portion 52 of the first engaging body 5. That plurality of arms of the casing portion 52 of the first engaging body 5 are angularly distributed around the axis of the first engaging body 5 and are positioned along a direction parallel to the axis of the first engaging body 5. The first drawing system 7 comprises a plurality of hollows defined by the shaft 2 on the outer lateral surface of the shaft 2. That plurality of hollows of the shaft 2 are angularly distributed around the longitudinal axis X and are positioned along a direction parallel to the longitudinal axis X. Those arms of the first drawing system 7, in the condition with the first engaging body 5 mounted in a sleeve-like way on the shaft 2, are inserted in those respective hollows of the first drawing system 7.

In FIGS. 5 and 7 the reference character 71a is used to label several arms of the first drawing system 7. In FIG. 7 the reference character 71b is used to label several hollows of the first drawing system 7.

The selecting system comprises a second drawing system 8. The second drawing system 8 is interposed between the second engaging body 6 and the shaft 2, so that corresponding to the rotary motion of the shaft 2 there is an equal rotary motion of the second engaging body 6. The second drawing system 8 comprises a plurality of arms which belong to the casing portion 62 of the second engaging body 6. That plurality of arms of the casing portion 62 of the second engaging body 6 are angularly distributed around the axis of the second engaging body 6 and are positioned along a direction parallel to the axis of the second engaging body 6. The second drawing system 8 comprises a second plurality of hollows defined by the shaft 2 on the outer lateral surface of the shaft 2. That plurality of hollows of the shaft 2 are angularly distributed around the longitudinal axis X and are positioned along a direction parallel to the longitudinal axis X. Those arms of the second drawing system 8, in the condition with the second engaging body 6 mounted in a sleeve-like way on the shaft 2, are inserted in those respective hollows of the second drawing system 8.

In FIGS. 5 and 7 the reference character 81a is used to label several arms of the second drawing system 8. In FIG. 7 the reference character 81b is used to label several hollows of the second drawing system 8.

The hollows of the first drawing system 7 are angularly inserted between the hollows of the second drawing system 8, so that both the first engaging body 5 and the second engaging body 6 can be subject to the respective sleeve-like movement relative to the shaft 2 and to the other engaging body, and can be simultaneously drawn by the rotary motion of the shaft 2.

In that way, a selecting system is obtained which is very compact and can be very fast when selecting the gears, since each engaging body is already rotating, before selecting each gear, together with the shaft 2.

The cam coupling 4 is configured so that the respective second part 422 of the first coupling element 42 is engaged with the first engaging body 5 so that the first coupling element 42 is uncoupled relative to the rotary motion of the first engaging body 5.

The cam coupling 4 comprises a first groove 44 fixed to and/or made in the first engaging body 4. The first engaging body 4 comprises a coupling portion 53 which defines the first groove 44. The respective second part 422 of the first element 42 is engaged with the first engaging body 5 by means of insertion of that second part 422 of the first element 42 in the first groove 44. The second part 422 of the first element can slide in that first groove 44. The first groove 44 extends continuously around the axis of the first engaging body 5, so that, by means of sliding of the second part 422 of the second element in the first groove 44, the first element 42 is uncoupled relative to the rotary motion of the first engaging body 5.

The cam coupling 4 is configured so that the respective second part 432 of the second element 43 is engaged with the second engaging body 6 so that the second coupling element 43 is uncoupled relative to the rotary motion of the second engaging body 6.

The cam coupling 4 comprises a second groove 45 fixed to and/or made in the second engaging body 6. The second engaging body 6 comprises a coupling portion 63 which defines the second groove 45. The respective second part 432 of the second element 43 is engaged with the second engaging body 6 by means of insertion of that second part 432 of the second element 43 in the second groove 45. The second part 432 of the second element 43 can slide in that second groove 45. The second groove 45 extends continuously around the axis of the second engaging body 6, so that, by means of sliding of the second part 432 of the second element 43 in the second groove 45, the second element 43 is uncoupled relative to the rotary motion of the second engaging body 6.

The cam coupling 4 comprises an anti-rotation body 46.

The anti-rotation body could be fixed relative to the above-mentioned fixed frame, not illustrated.

The anti-rotation body defines an axis of the anti-rotation body 46. The anti-rotation body 46 has a respective axial development or extent along its axis and a respective angular development or extent around its axis. The anti-rotation body 46 is positioned and/or mounted so that the respective axis coincides with the longitudinal axis X.

Since the anti-rotation body 46 has an angular development or extent around its axis and since its axis coincides with the longitudinal axis X, the anti-rotation body 46 is positioned around the longitudinal axis X.

Since the anti-rotation body 46 has an axial development or extent along its axis and since its axis coincides with the longitudinal axis X, the anti-rotation body 46 is positioned along the longitudinal axis X.

Therefore, the anti-rotation body 46 is positioned along and around that longitudinal axis.

Therefore, the anti-rotation body 46 is positioned coaxially relative to that longitudinal axis X and/or on the longitudinal axis X.

Therefore, the anti-rotation body 46 and the selecting body 3 are positioned coaxially relative to each other. The anti-rotation body 46, selecting body 3, first engaging body 5 and second engaging body 6 are therefore positioned coaxially relative to each other and coaxially relative to the shaft 2.

The second engaging body 6, the first engaging body 5, the anti-rotation body 46 and the selecting body 3 are positioned one after the other along the above-mentioned radial extent of the selecting system.

The angular development of the anti-rotation body 46 is a substantially circular development around its axis. Therefore, the anti-rotation body 46 could be considered a bell-housing or anti-rotation unit interposed, along the above-mentioned radial extent, between the engaging bodies 5 and 6 and the selecting body 3.

The anti-rotation body 46 is shown in cross-section in FIGS. 1, 2, 3, 4, 5, in accordance with the above-mentioned first sectioning surface.

In FIGS. 1A, 2A, 3A, 4A and 5A, the anti-rotation body 46 is shown in cross-section according to the above-mentioned second sectioning surface, which is orthogonal to the longitudinal axis X. Therefore, in FIGS. 1A, 2A, 3A, 4A and 5A, the angular development of the anti-rotation body 46 is visible.

The anti-rotation body 46 holds the first coupling element 42 in a first angular position around the axis of the anti-rotation body 46, and therefore in a first angular position around the longitudinal axis X. The anti-rotation body 46 holds the second coupling element 43 in a second angular position around the axis of the anti-rotation body 46, and therefore in a second angular position around the longitudinal axis X.

Those first and second angular positions are angularly spaced from each other so that said rotary movement of the selecting body 3 causes sliding of the first part 421 of the first element 42 and, sequentially, sliding of the first part 431 of the second element 43 along said variable stretch 411 of the channel 41, so that the respective coupling conditions of the gears I11 to I22 occur sequentially, and therefore so that the gears are sequentially selected.

The channel 41 extends along the angular development of the selecting body 3. The variable stretch 411 extends along a sector S of the angular development of the selecting body 3. That sector S has an angular amplitude around the longitudinal axis X. The extent of the channel is schematically illustrated in FIG. 6. That sector S is indicated in FIG. 5A and in FIG. 6. The amplitude value of the sector S is labelled α in FIG. 5A, in which the sector S is also labelled α.

In FIGS. 1, 2, 3, 4 and 5, the cross-section line along which the above-mentioned first sectioning surface is positioned, is positioned so that the above-mentioned first and second stretches of that cross-section line are inclined one relative to the other at an angle equal to α, and so that the first sectioning surface intersects both the first coupling element 42 and the second coupling element 43. Therefore, in FIGS. 1, 2, 3, 4 and 5, even the first coupling element 42 and the second coupling element 43 are sectioned according to the above-mentioned first sectioning surface.

Since the above-mentioned operating movements are at least partly alternating, that variable stretch is at least partly curved. That variable stretch could be shaped at least partly in a sinusoidal way. In that sense, that stretch could comprise part of a sinusoid, for example a half sinusoid.

In the schematic illustrations in FIGS. 1 to 6, and in the preferred embodiment of FIGS. 7 and 8, that variable stretch 411 has the shape of a complete sinusoid.

In FIG. 6 the sinusoidal shape of the variable stretch 411 is clear to see. Even in FIG. 7 that sinusoidal shape is visible.

That means that said variable stretch comprises a complete sinusoid. The cam coupling 4 is configured so that sliding of the first part 421 of the first element 42 along the sinusoid causes the operating movement of the first engaging body 5.

FIG. 6 shows three possible positions of the first part 421 of the first coupling element 42. Those three positions are a starting position P0, a first position P1 and a second position P2. When the first part 421 of the first element 42 is in the starting position P0, the selecting body 3 is positioned relative to the first element 42, around the longitudinal axis X, as in FIG. 5A, and the first engaging body 5 adopts the respective non-operating condition of FIG. 5. When the first part 421 of the first element 42 is in the first position P1, which is a first end point of the sinusoid, the selecting body 3 is positioned relative to the first element 42, around the longitudinal axis X, as in FIG. 1A, and the first engaging body 5 adopts the respective first engaged condition of FIG. 1. When the first part 421 of the first element 42 is in the second position P2, which is a second end point of the sinusoid, the selecting body 3 is positioned relative to the first element 42, around the longitudinal axis X, as in FIG. 2A, and the first engaging body 5 adopts the respective second engaged condition of FIG. 2. Therefore, when the first part 421 of the first coupling element 42 is in the first end position, first gear is selected, and when the first part 421 of the first coupling element 42 is in the second end position P2, second gear is selected.

The first part 421 of the first element 42, in the figure, can be considered alternatively as the first part 431 of the second element 43. When the first part 431 of the second element 43 is in the starting position P0, the selecting body 3 is positioned relative to the second element 43, around the longitudinal axis X, as in FIG. 2A, and the second engaging body 6 adopts the respective non-operating condition of FIG. 2. When the first part 431 of the second element 43 is in the first position P1, which is a first end point of the sinusoid, the selecting body 3 is positioned relative to the second element 43, around the longitudinal axis X, as in FIG. 3A, and the second engaging body 6 adopts the respective first engaged condition of FIG. 3. When the first part 431 of the second element 43 is in the second position P2, which is a second end point of the sinusoid, the selecting body 3 is positioned relative to the second element 43, around the longitudinal axis X, as in FIG. 4A, and the second engaging body 6 adopts the respective second engaged condition of FIG. 4. Therefore, when the first part 431 of the second element 43 is in the first end position P1, third gear is selected, and when the first part 431 of the second element 43 is in the second end position P2, fourth gear is selected.

The angular distance between the first angular position, in which the anti-rotation body 46 holds the first coupling element 42, and the second angular position, in which the anti-rotation body 46 holds the second element 43, is an angle sufficient to ensure that said rotary movement of the selecting body 3 sequentially causes sliding of the first part 421 of the first coupling element 42 along the variable stretch 411 and sliding of the first part 432 of the second coupling element 43 along the variable stretch 411, so that the gears are selected sequentially, and therefore so that the respective coupling conditions of the gears I11 to I22 with the rotary motion of the shaft 2 occur sequentially.

In that way, the gears are selected sequentially with a very compact selecting system, controlled by a selecting body that is coaxial relative to the axis of the shaft 2.

As shown in FIG. 6. That angular distance could be equal to α, and therefore equal to the amplitude value of the angular sector S along which the variable stretch 411 of the channel 41 extends.

The anti-rotation body 46, while holding the first element 42 in the first angular position, is configured to guide, during sliding of the first part 421 of the first element 42 in the variable stretch 411 of the channel 41, the above-mentioned longitudinal motion component of the first element 42. For that purpose, the anti-rotation body 46 comprises a first guide 461. That first guide is shown in FIGS. 1, 5 and 7.

The anti-rotation body 46, while holding the second element 43 in the second angular position, is configured to guide, during sliding of the first part 431 of the second element 43 in the variable stretch 411 of the channel 41, the above-mentioned longitudinal motion component of the second element 43. For that purpose, the anti-rotation body 46 comprises a second guide 462. That second guide 462 is shown in FIGS. 3 and 5.

The selecting body 3 is positioned, relative to the above-mentioned radial direction relative to the longitudinal axis X, around and coaxial relative to the respective coupling portion 53 of the first engaging body 5.

The selecting body 3 is positioned, relative to the above-mentioned radial direction, around and coaxial relative to the respective coupling portion 63 of the second engaging body 6.

The selecting body 3 is positioned, relative to the above-mentioned radial direction, around and coaxial relative to the anti-rotation body 46. The anti-rotation body 46 is interposed, relative to the above-mentioned radial direction, between the respective coupling portions 43 and 63 and the selecting body 3.

The first gear I11 associated with the first engaging body 5 could be considered a first gear of the gearbox. The second gear I12 associated with the first engaging body 5 could be considered a second gear of the gearbox. The first gear I21 associated with the second engaging body 6 could be considered a third gear of the gearbox. The second gear I22 associated with the second engaging body 6 could be considered a fourth gear of the gearbox.

FIGS. 7 and 8 show, among the gears, the second gear I12 associated with the first engaging body 5 and, among the coupling elements, only the first coupling element 42.

FIGS. 7 and 8 relate to a specific preferred embodiment of the sequential gearbox. FIGS. 7 and 8 only show the gear I12 and some components of the gearbox.

A sequential gearbox in accordance with this description can be used, for example, in any vehicle.

This description also relates to a vehicle comprising a gearbox in accordance with this description.

1. A sequential gearbox comprising:
a shaft which may be subject to a rotary motion around a longitudinal axis of said shaft;
a plurality of gears which are idly mounted on said shaft, each of which can adopt a respective coupling condition with said rotary motion of the shaft, said respective coupling condition corresponding to the selection of a respective gear of the gearbox;
a selecting system which comprises a selecting body, said selecting body defining an axis of the selecting body and being mounted so that the respective axis coincides with said longitudinal axis ;
wherein said selecting body is mounted so that it can be subject to a rotary movement around said axis of the selecting body;
wherein the selecting system comprises a cam coupling configured for making said rotary movement sequentially cause the respective coupling conditions of the gears.

2. The sequential gearbox according to claim 1, wherein:
said selecting system comprises at least one first engaging body and one second engaging body;
wherein each of said engaging bodies is associated with a respective first gear and with a respective second gear of said plurality, in such a way as to be able to adopt a respective non-operating condition, in which it does not cause the coupling condition of any gear, a respective first engaged condition, in which it causes the coupling condition of the respective first gear, and a respective second engaged condition, in which it causes the coupling condition of the respective second gear;
wherein said first engaging body is mounted relative to the shaft in such a way as to be able to be subject to a sleeve-like operating movement relative to the shaft, said sleeve-like operating movement being at least from the respective non-operating condition to the respective first engaged condition, from the respective first engaged condition to the respective second engaged condition, and from the respective second engaged condition to the respective non-operating condition;
wherein said second engaging body is mounted relative to the shaft in such a way as to be able to be subject to a sleeve-like operating movement relative to the shaft, said operating movement of the second engaging body being at least from the respective non-operating condition to the respective first engaged condition and from the respective first engaged condition to the respective second engaged condition;
wherein each of said engaging bodies is mounted in a sleeve-like way on said shaft, so that the respective operating movement is a sleeve-like movement relative to said shaft;
wherein said cam coupling couples said rotary movement of the selecting body to the respective operating movements of said engaging bodies, so that said rotary movement sequentially causes the operating movement of the first engaging body and the operating movement of the second engaging body;
wherein each of said engaging bodies defines a respective axis of the respective engaging body and is mounted relative to the shaft so that the respective axis coincides with said longitudinal axis;
wherein each of said engaging bodies has a respective axial development along its axis and a respective angular development around its axis, in such a way as to be positioned along and around said shaft;
wherein said selecting body has a respective axial development along its axis and a respective angular development around its axis, in such a way as to be positioned along and around said longitudinal axis of the shaft;
wherein said selecting body is positioned coaxially relative both to said first engaging body and to said second engaging body;
wherein said first engaging body and second engaging body are positioned coaxially relative to each other and coaxially relative to the shaft, so that the operating movement of each of said engaging bodies is also a sleeve-like movement relative to the other engaging body.

3. The sequential gearbox according to claim 2, wherein said cam coupling comprises a channel defined by the selecting body and, for each of said engaging bodies, a respective coupling element;
wherein each coupling element comprises a respective first part engaged with said channel, and a respective second part engaged with the respective engaging body;
wherein said cam coupling is configured so that, for each coupling element, said rotary movement of the selecting body corresponds to sliding of the first part of the respective coupling element along said channel;
wherein said channel comprises at least one variable stretch;
wherein said cam coupling is configured so that, for each of said coupling elements, the sliding of the first part of the respective coupling element in the variable stretch causes at least one longitudinal motion component of the respective coupling element, said longitudinal motion component being along a direction parallel to said longitudinal axis;
wherein said cam coupling is configured so that, for each of said coupling elements, by means of the engagement of the respective second part with the respective engaging body, the longitudinal motion component of the respective coupling element causes the operating movement of the respective engaging body.

4. The sequential gearbox according to claim 3, wherein said selecting system comprises, for each of said engaging bodies, a drawing system interposed between the respective engaging body and said shaft, so that corresponding to said rotary motion of the shaft there is an equal rotary motion of the respective engaging body;
wherein said cam coupling is configured so that, for each coupling element, the respective second part is engaged with the respective engaging body so that the respective coupling element is uncoupled relative to the rotary motion of the respective engaging body.

5. The sequential gearbox according to claim 4, wherein said selecting system comprises an anti-rotation body which defines an axis of the anti-rotation body and is mounted so that the respective axis coincides with said longitudinal axis;
wherein said anti-rotation body holds each coupling element in a respective angular position around said longitudinal axis, so that said rotary movement sequentially causes the respective slidings of the respective first parts of said coupling elements along said variable stretch.

6. The sequential gearbox according to claim 5, wherein the cam coupling comprises, for each engaging body, a respective groove fixed to the respective engaging body, each engaging body comprising a respective coupling portion which defines the respective groove;
wherein, for each coupling element, the respective second part of the respective element is engaged with the respective engaging body by means of insertion of that respective second part in the grove of the respective engaging body;
wherein, for each coupling element, the second part of the respective element can slide in the respective groove;
wherein each groove extends around the axis of the respective engaging body, so that, by means of sliding of the second part of the respective coupling element in the respective groove, the respective coupling element is uncoupled relative to the rotary motion of the respective engaging body.

7. The sequential gearbox according to claim 6, wherein each engaging body comprises, along the respective axis, a respective engaging portion which causes engagement of the respective first gear or of the respective second gear, a respective casing portion which makes the respective operating movement a sleeve-like movement relative to the shaft, and a respective coupling portion which defines the respective groove;
wherein the selecting body is positioned, relative to a radial direction relative to the longitudinal axis around and coaxially relative to the respective coupling portions of the respective engaging bodies and around and coaxially relative to the anti-rotation body, said anti-rotation body being interposed, along said radial direction, between said coupling portions and said selecting body.

8. The sequential gearbox according to claim 7, wherein the anti-rotation body, for each of the coupling elements, is configured for guiding the respective longitudinal motion component, during the sliding of the first part of the respective coupling element in the variable stretch of the channel.

9. The sequential gearbox according to claim 1, wherein:
said plurality of gears comprises a first gear and a second gear;
said selecting system comprises at least one first engaging body associated with said first gear and with said second gear, in such a way as to be able to adopt a non-operating condition, in which it does not cause the coupling condition of any gear, an engaged condition of the first gear, in which it causes the coupling condition of the first gear, and an engaged condition of the second gear, in which it causes the coupling condition of the second gear;
wherein said first engaging body is mounted relative to said shaft in such a way as to be able to be subject to a sleeve-like operating movement relative to the shaft, said operating movement of the first engaging body being at least from the non-operating condition to the engaged condition of the first gear, and from the engaged condition of the first gear to the engaged condition of the second gear;
wherein said first engaging body is mounted in a sleeve-like way on said shaft, so that said operating movement is a sleeve-like movement relative to said shaft;
wherein said cam coupling couples said rotary movement to said operating movement, so that said rotary movement causes said operating movement;
wherein said cam coupling couples said rotary movement of the selecting body to the operating movement of said engaging body, so that said rotary movement causes said operating movement;
wherein said first engaging body defines a respective axis of the respective engaging body and is mounted relative to the shaft so that the respective axis coincides with said longitudinal axis;
wherein said first engaging body has a respective axial development along its axis and a respective angular development around its axis, in such a way as to be positioned along and around said shaft;
wherein said selecting body has a respective axial development along its axis and a respective angular development around its axis, in such a way as to be positioned along and around said longitudinal axis of the shaft;
wherein said selecting body is positioned coaxially relative to said first engaging body;
wherein said first engaging body is positioned coaxially relative to the shaft and so that the shaft is inserted through said first engaging body.

10. The sequential gearbox according to claim 1, wherein:
said plurality of gears comprises a first gear and a second gear;
said selecting system comprises at least one first engaging body associated with said first gear, in such a way as to be able to adopt a respective non-operating condition, in which it does not cause the coupling condition of any gear, and an engaged condition of the first gear, in which it causes the coupling condition of the first gear;
said selecting system comprises at least one second engaging body associated with said second gear, in such a way as to be able to adopt a respective non-operating condition, in which it does not cause the coupling condition of any gear, and an engaged condition of the second gear, in which it causes the coupling condition of the second gear;
wherein said first engaging body is mounted relative to said shaft in such a way as to be able to be subject to a sleeve-like operating movement relative to said shaft, said operating movement of the first engaging body being at least from the respective non-operating condition to the engaged condition of the first gear, and from the first engaged condition to the respective non-operating condition;
wherein said second engaging body is mounted relative to said shaft in such a way as to be able to be subject to a sleeve-like operating movement relative to said shaft, said operating movement of the second engaging body being at least from the respective non-operating condition to the engaged condition of the second gear;
wherein each of said engaging bodies is mounted in a sleeve-like way on said shaft, so that the respective operating movement is a sleeve-like movement relative to said shaft;
wherein said cam coupling couples said rotary movement of the selecting body to the respective operating movements of said engaging bodies, so that said rotary movement sequentially causes the operating movement of the first body and the operating movement of the second body;
wherein said each of said engaging bodies defines a respective axis of the respective engaging body and is mounted relative to said shaft so that the respective axis coincides with said longitudinal axis;
wherein each of said engaging bodies has a respective axial development along its axis and a respective angular development around its axis, in such a way as to be positioned along and around said shaft;
wherein said selecting body has a respective axial development along its axis and a respective angular development around its axis, in such a way as to be positioned along and around said longitudinal axis of the shaft;
wherein said selecting body is positioned coaxially both relative to said first engaging body and relative to said second engaging body;
wherein said first engaging body and second engaging body are positioned, coaxially relative to each other and coaxially relative to the shaft, so that the shaft is inserted through both the first body and the second body and so that the operating movement of each of said engaging bodies is also a sleeve-like movement relative to the other engaging body.
